(19) United States
(12) Patent Application Publication
(10) Pub. No.: US 2007/0095045 A1
(43) Pub. Date: May 3, 2007

(54) Silver chain manufacture

(75) Inventor: Peter Gamon Johns, Hertfordshire (GB)

Correspondence Address: KELLEY DRYE & WARREN LLP, 400 ATLANTIC STREET, 13TH FLOOR, STAMFORD, CT, 06901, US

(73) Assignee: MIDDLESEX SILVER CO. LIMITED, London (GB)

(21) Appl. No.: 10/582,068

(22) PCT Filed: Dec. 9, 2004
(86) PCT No.: PCT/GB04/50037

§ 371 Date: Jun. 8, 2006

(30) Foreign Application Priority Data
Dec. 10, 2003 (GB) 0328603.6

(51) Int. Cl. F16G 13/00

(52) U.S. Cl. 59/80

(57) ABSTRACT

A method for silver chain manufacture comprises forming lengths of silver wire into successive chain links whose ends abut using an automatic chain forming machine, and closing the links by brazing or welding abutting ends thereof, by means or a laser. The wire comprises at least 92.5 wt % Ag and about 0.5aboul 3 wt % Gc and speeds of 100-250 links per minute can be achieved. The invention also relates to a silver chain.

### FIELD OF THE INVENTION

The present invention relates to a process for the manufacture of silver chain and to silver chain obtainable by the above process.

### BACKGROUND OF THE INVENTION

In the machine manufacture of chains, wire to be formed into the chain is cut to length and bent into links each link being formed or threaded through the one preceding it so that a chain results. The links ends of each link then have to be fastened together to stabilise the chain mechanically.

Up to now silver solder-cored wire is the preferred starting material for use in manufacturing such chains. Such wire and its production are described in U.S. Pat. No. 978,847 (Carlisle, 1910), the disclosure of which is incorporated herein by reference. That specification explains that an ingot of silver intended for reduction into wire is formed with a core of solder extending longitudinally through the ingot, after which the ingot is reduced by swaging machines, rolls, or both or by extrusion and drawing to the diameter intended for formation into chains. The manufacture of such wire is disclosed in U.S. Pat. No. 1,465,553 (Bleecker), U.S. Pat. No. 2,138,088 (Capillon) and U.S. Pat. No. 4,247,602 (Krug), the disclosures of which are also incorporated herein by reference, and in Reti et al., precious Metal Chain, Santa Fe Symposium on Jewellery Manufacturing Technology, 1991, 287-299 which reviews the manufacture of precious metal chains including gold and silver chain. In chains formed from such wires the ends of the links abut, and soldered joints closing the links can be made by subjecting the chains to heat in a furnace under a reducing atmosphere at about 720° C. Normally continuous belt furnaces are used for this purpose and talc is applied to the surface of the chain in order to reduce or prevent spread of the solder beyond the abutting regions to be joined. However, the production of the wire used as starting material is energy intensive and the coating with talc and subsequent removal thereof add to the cost and complexity of the manufacturing process.

An alternative technique uses solid wire as the starting material and applies solder powder prior to heating in a furnace to solder the abutting ends of the links together as discussed by Reti et al, supra. Solvent-cleaned chain is immersed into a mixture of solvent, castor oil and solder powder which permits entry of the solder into the small spaces between the links. The solvent is dried and the chain is shaken in talc in order to remove powdered solder from the external surface of the chain and to provide protection for the surface of the chain, after which the chain is heated in a belt-type furnace to solder the links closed, and the talc is removed. However, particularly in silver, it is difficult to solder or weld all the links of a chain consistently, and objectionable firestain is observed in Sterling silver. The application of the solder powder is a laborious process and the subsequent talc coating and removal steps add to manufacturing cost.

Machines for making jewellery chain in gold or other precious metals from wire of precious metal alloy are commercially available, and the links of the chain can be closed on-line during the manufacturing process by laser, gas plasma micro-torch or electric discharge welding although the above mentioned furnace treatment remains the more common option for silver chains. Manufacturers of chain making machines include O.M.B.I. Spa of Milan, Italy and Sisma Spa of Schio, Italy, see also U.S. Pat. No. 5,278,389.

The welding of silver chain presents greater difficulties than gold chain because of the high reflectivity and high thermal conductivity of jewellery grades of silver. For personal wear, the chain should be a grade of silver of at least Sterling silver content because grades with high copper content do not perform well in contact with the skin, although they are sold in some countries for use as tableware. Although some equipment manufacturers claim to provide e.g. automatic chain forming and welding machines that they allege can be used to make silver chain, currently available machines do not give sufficiently reliable results using Sterling silver and measures such as blackening the chain links by oxidation in order to improve heat uptake involve additional and potentially expensive manufacturing steps and are not fully effective.

### SUMMARY OF THE INVENTION

We have now found that silver wire containing at least 92.5 wt % Ag and about 0.5- about 3 wt % Ge, the balance being copper or other conventional alloying ingredients, preferably boron as grain refiner, and impurities, can be formed into links and the links can be welded closed on conventional automatic chain forming and welding machines with sufficient reliability to make chain of indefinite length at commercially useful speeds e.g. 100-250 links per minute. Surprisingly, the conditions that can be used for welding are generally similar to those for welding gold chain. In the case of laser welding, which is preferred, powers of 20-80 W, e.g. about 30 W may be used, and the heat may be conveyed from the laser to the site of the weld by means of an optical fibre cable.

In one aspect the invention provides a silver chain which comprises lengths of silver wire formed into successive links whose ends abut and are closed by brazed or welded joints, wherein the wire comprises at least 92.5 wt % Ag and about 0.5- about 3 wt % Ge.

In a further aspect, the invention provides a method of making silver chain which comprises forming lengths of silver wire into successive chain links whose ends abut, and closing the links by brazing or welding abutting ends thereof by means of a laser, wherein the wire comprises at least 92.5 wt % Ag and about 0.5- about 3 wt % Ge.

### DESCRIPTION OF PREFERRED FEATURES

The wire used to make the present chains may be of circular cross section, but other sections may be employed, e.g. oval, polygonal, strip or flat wire depending on the appearance desired for the finished chain. The wire will typically be of circular section and of diameter 0.008-0.20 cm (0.003-0.08 inches), more usually 0.013-0.08 cm (0.005-0.030 inches). The chains that may be made according to the invention may comprise rope chains, cable-link chains, curb link chains, Figaro chains (i.e. a chain of alternating short and long links), Spiga chains, Otto chains, Russa chains and the like, for whose formation automatic chain-making machines are available from a variety of suppliers as indicated above. The present chains will usually be entirely or predominantly of silver, but embodiments may include chains made from silver wire together with wire of other precious metals e.g. gold and/or wire of semi-precious or other metals.

The wire should contain germanium at least in its surface layers in an amount sufficient to facilitate laser welding. It may be, for example, of the alloy described in GB-B-2255348 (Rateau, Albert and Johns; Metaleurop Recherche). That alloy maintains the maintained the properties of hardness and lustre inherent in Ag—Cu alloys while reducing problems resulting from the tendency of the copper content to oxidise. The alloys are ternary Ag—Cu—Ge alloys containing at least 92.5 wt % Ag, 0.5-3 wt % Ge and the balance, apart from incidental ingredients and impurities, copper. The alloys are stainless in ambient air during conventional production, transformation and finishing operations, easily deformable when cold, exhibit superior ductility and tensile strength compared to Sterling silver and are annealable.

Patents U.S. Pat. No. 6,168,071 and EP-B-0729398 (Johns) disclose silver/germanium alloy that may be used in the present process and which for present purposes of jewellery chain making should comprises a silver content of at least 92.5 wt % and a germanium content of between 0.4 and 7%, the remainder principally being copper apart from any incidental ingredients and impurities, said alloys containing elemental boron as a grain refiner at a concentration of greater than 1 ppm and less than 40 ppm e.g. about 4-8 ppm. The boron content of the alloy could be achieved by providing the boron in a master copper/boron alloy having 2 wt % elemental boron. Such low concentrations of boron provide excellent grain refining in a silver/germanium alloy, imparting greater strength and ductility to the alloy compared with a silver/germanium alloy without boron. Compared to a weld in Sterling silver, a weld in the above-described alloy had a much smaller average grain size that improves the formability and ductility of the welds. A more recently developed ternary silver-copper-germanium alloy that may be used in the present process has Ag 94.5 wt %, Ge 1.2 wt %, Cu 4.1 wt % and B=0.0008 wt % (8 ppm). It may be prepared by melting silver, copper and germanium together at 1050° C. under an atmosphere of nitrogen, and adding the boron as a copper-boron master alloy at the last possible moment.

The properties and use of the above alloys are discussed in a paper by Peter Johns, Firestain Resistant Silver Alloys, Santa Fe Symposium on Jewellery Manufacturing Technology, 1997, pages 33-67 and online by Jeffrey Herman of the Society of American Silversmiths at http://www.silversmithing.com/1argentium.htm. In particular, addition of germanium reduces the electrical and thermal conductivity of silver alloys. The International Annealed Copper Scale provides a measure of electrical conductivity of metals. On this scale, the value for copper is 100%, that of pure silver is 106%, that of Sterling silver is 96%, that of an alloy containing 1.1 wt % Ge is 56%, and that of an alloy containing 2.5 wt % Ge is 23%. Thermal conductivity becomes reduced as electrical conductivity is reduced.

It will be understood that variants of the above alloys may be employed incorporating minor amounts of other alloying ingredients, but the presence of such additional ingredients may not exhibit positive effects. Examples include cadmium (less preferred on the ground of toxicity) and/or zinc (less preferred on the ground of problems of hardness reduction, volatility and laser welding) to at least partly replace the copper, silicon e.g. in an amount of up to 0.25 wt % preferably 0.1 wt % or less, nickel e.g. in an amount of up to 0.25% (also less preferred in chain intended to come into skin contact on the ground of toxicity and allergenic reactions) and small amounts of manganese or indium. Such alloying ingredients in small amounts that are not detrimental to the corrosion resistance of the alloy, its welding properties, or its physical properties and formability are included within the expression “incidental ingredients”.

Silver alloy according to the teaching of GB-B-2255348 and EP-B-0729398 is now commercially available in Europe and in the USA under the trade name Argentium, and the word “Argentium” as used herein refers to these alloys. The 925-grade Argentium alloy comprises 92.5 wt % (minimum) Ag, 1.1-1.3 wt % Ge, 6 ppm B, the balance being copper and impurities. The alloy shows excellent resistance to tarnishing even under very arduous conditions. A passive layer is formed by the germanium, which significantly slows the formation of silver sulphide, the main cause of tarnishing on conventional silver alloys. Even in a hydrogen sulphide atmosphere the degree and depth of tarnish is significantly less compared to a conventional silver alloy or a silver plated item. The same mechanism that creates the tarnish resistance also results in the formation of a passive layer which significantly reduces the depth of ‘fire-staining’ or the ‘fire layer’ that is produced in this alloy e.g. when welding. Trials have shown that the depth of the ‘fire-staining’ to be up to three times greater in conventional silver alloys compared to the Argentium silver alloys. This reduces the amount of polishing that the alloy requires and can result in other considerable cost savings in manufacturing.

It is believed that there are significant advantages flowing from the development of a surface oxide layer on Argentium sterling and other germanium-containing silver alloys. It is believed that the surface oxide layer results in a greater consistency in the laser welding process. The oxide layer may be predominantly germanium oxide. Alternatively it may be germanium oxide and copper oxide. For example, it has surprisingly been found that improved weldability can be obtained without blackening the surface as with a pen in the prior art and without noticeable colour change from the oxide film.

An oxide layer may be formed in the wire used to form the chain e.g. by annealing in air or in a wet selectively oxidising atmosphere of the kind disclosed in WO 02/095082, the contents of which are incorporated herein by reference. That application discloses mildly oxidising conditions, i.e. temperatures and oxygen partial pressures, which allow the Ag—Cu—(Zn)—Ge alloys to be processed such that Ge will react to form Ge0₂ without Cu forming Cu₂O. However, restrictions on the maximum processing temperature and time at temperature arise from the normal commercial annealing temperature and time used for producing silver-copper alloys such as Sterling silver, typically about 625° C. or 650° C. We have established that the Ag—Cu (Zn)—Ge alloys can be processed even at annealing temperatures such as 625° C. and 650° C. to selectively oxidise Ge to GeO₂, by using a controlled atmosphere such that the range of oxygen potential provided by the atmosphere at temperature forms Ge0₂ whilst preventing the formation of Cu₂O.

The atmosphere may comprise at least one non-oxidising gas, which may be an inert gas such as argon or nitrogen, or, preferably, a reducing gas such as hydrogen, dissociated ammonia or carbon monoxide. Accordingly, suitable non-oxidising gases include hydrogen, dissociated ammonia, carbon monoxide, nitrogen, argon, or mixtures thereof. In addition, the atmosphere comprises at least one oxidising gas such as H₂O (steam), oxygen or carbon dioxide. The proportions of non-oxidising and oxidising gases will be chosen to provide an oxygen potential, at the annealing temperature used, such that germanium is selectively oxidised to germanium oxide. Suitably, the selectively oxidising atmosphere comprises hydrogen and H₂O, or carbon monoxide and carbon dioxide, or is of argon or nitrogen and oxygen. For example, in one embodiment, the selectively oxidising atmosphere is provided by an inert gas such as, but not limited to, argon or nitrogen, to which a controlled amount of oxygen has been added. Typically, the oxygen is added so as to provide an atmosphere having an oxygen content of from 0.1 to 0.5 vol. %.

Preferably, the atmosphere is a wet selectively oxidising atmosphere. By ‘wet’ in this context is meant an atmosphere containing moisture (H₂O), such that the atmosphere exhibits a dew point of at least +1° C., preferably at least +25° C., more preferably at least +40° C. Preferably, the dew point falls within the range from +1° C. to +80° C., more preferably in the range from +2° C. to +50° C. The dew point may be defined as the temperature to which an atmosphere containing water vapour must be cooled in order for saturation to occur, whereby further cooling below the dew point temperature results in the formation of dew. A more comprehensive definition is given in “Handbook of Chemistry and Physics”. 65th Edition (1985-85), CRC Press Inc., USA, page F-75. We prefer that the selectively oxidising atmosphere comprises hydrogen and moisture, for example an atmosphere of nitrogen, hydrogen and water vapour, such as a 95% nitrogen/5% hydrogen gas mixture (v/v) containing water vapour, or a furnace atmosphere of nitrogen, hydrogen, carbon monoxide, carbon dioxide, methane, and water vapour.

In practice, it is preferred to produce the wet selectively oxidising atmosphere by controlling the addition of water vapour to a substantially dry inert or dry reducing furnace atmosphere, for example to a furnace atmosphere of predominantly nitrogen or nitrogen and hydrogen, and typically comprising nitrogen, hydrogen, carbon monoxide, carbon dioxide and methane. The dew point in the furnace can be measured by conventional means such as a dew point meter or probe in the furnace, and the gas mixing ratios adjusted accordingly in order to control the selectively oxidising atmosphere.

The annealing of the alloy should be carried out under the selectively oxidising atmosphere. If, as is usual, the annealing is carried out aS successive annealing steps, for example with intervening wire drawing steps, then at least the final annealing step should be carried out under the selectively oxidising atmosphere. The annealing is carried out at a temperature in the range from 400° C. to 750° C., typically in the range from 400° C. to 700° C., preferably in the range from 500° C. to 675° C., more preferably in the range from 600° C. to 650° C., and in particular at about 625° C. The annealing is suitably carried out for a total period in the range of from 5 minutes, at the higher annealing temperatures, to 1 hours, at the lower annealing temperatures, and preferably in the range from 15 minutes to 1 hour.

As a result of processing and annealing the alloy, preferably repeatedly, the germanium oxide is believed to become concentrated at the grain boundaries and to extend into the surface of the alloy, and can thus protect the copper from oxidation and consequent firestaining. Also, tests have shown that it is germanium oxide or dioxide that prevents the formation of silver sulphides. Thus, a silver-copper-germanium ternary alloy or a silver-copper-zinc-germanium quaternary alloy having excellent firestain resistance and tarnish resistance can be realised using the method according to the present invention. Furthermore the presence of an oxide layer, as mentioned above, is believed to improve laser weldability on a high-speed chain-welding machine.

The wire used in the present process is preferably of the same composition throughout its cross section (solid), in which case it may be made wholly of one of the alloys described above. Where a soldered joint between the abutting ends of the links is acceptable, however, the wire may be of the solder-cored type made e.g. by extrusion of a solder-cored billet.

In that case the outer portion of the wire may be of a ductile high silver content Ag—Ge binary alloy e.g. about Ag 99 wt %, Ge about 0.5-3 wt % preferably about 1 wt %, balance incidental ingredients and/or impurities.

The core may be of a soft silver brazing composition, e.g. such a composition having a solidus temperature of from about 600° C. to about 705° C. and a liquidus temperature of from about 650° C. to about 725° C. Particularly preferred are very low melting Ge-containing brazing compositions (solidus temperature of from about 600° C. to about 630° C. and a liquidus temperature of from about 650° C. to about 680° C.) having a silver content of at least 55 wt %, or to meet legislative requirements in some jurisdictions at least 65 wt % Ag. The presence of germanium improves colour and tarnish resistance and lowers melting point. A suitable ductile low-melting composition for the core which is of good colour and provides joints of good surface texture may be made by melting together the following materials: Ag 58%, Ge 2%, Sn 2.5%, Zn 14.5%, Si 0.1%, B 0.14% and Cu 22.76% (solidus about 615° C., liquidus about 650° C.). A further suitable composition of higher silver content but without added tin comprises Ag 60%, Ge 2%, Zn 13%, Si 0.1% and Cu 24.9%. A suitable composition containing >65 wt % Ag comprises Ag 67%, Ge 2%, Zn 8%, Si 0.1% and Cu 22.9%. An alternative high silver content composition comprises Ag 70%, Ge 2%, Zn 8%, Si 0.1%, and Cu 19.9%.

The proportions of the core and outer portion and their compositions should be selected so that the finished chain has an overall silver content of not less than 92.5%.

In an experiment, 0.04 cm (0.015″) diameter wire of the above-described alloy of silver content 94.5% and Germanium content 1.2 wt % was formed into an oval-linked cable chain using an automatic chain-forming machine and the links were welded closed using a laser built into the machine which was of power output 30 W. The chain was formed at a speed of about 155-160 links per minute using about 97% of the available power of the laser. An oval spot of light was formed at the place where the welds were to be made so as to spread the incident energy along the line of the butt joint to be formed in each link. The resulting chain was burnished in a vibratory polishing machine to give a chain having a very bright lustre. Examination of the welded joints in an optical microscope showed consistent clean joints free from observable laser impact or burn marks, sootiness or firestain and similar to joints in a conventional gold chain. An inert gas (argon) atmosphere was not required for formation of satisfactory welds or absence of firestain. The links of the resulting chain showed small grain size in the heat affected zone. The resulting chain was required to exhibit a braking load of about 27 N (6 lbf) and exhibited a braking load of about 40 N (9 lbf) as compared to a comparable soldered chain in Sterling silver which had a braking load of about 36 N (8 lbf).

The above process can also be used in the manufacture of bracelets for the welding of rivets to the ends of chains.

1. A method of making silver chain which comprises forming lengths of silver wire into successive chain links whose ends abut, and closing the links by brazing or welding abutting ends thereof by means of a laser, wherein the wire comprises at least 92.5 wt % Ag and about 0.5- about 3 wt % Ge.

2. The method of claim 1, wherein the wire is of diameter 0.008-0.20 cm (0.003-0.08 inches).

3. The method of claim 1, wherein the wire is of diameter 0.013-0.08 cm (0.005-0.030 inches).

4. The method of any preceding claim, wherein the composition of the wire in cross section is constant.

5. The method of claim 4, wherein the wire is of a ternary Ag—Cu—Ge alloy containing at least 92.5 wt % Ag, 0.5-3 wt % Ge, elemental boron as a grain refiner at a concentration of 1-40 ppm and the balance, apart from incidental ingredients and/or impurities, copper.

6. The method of claim 4, wherein the wire is of a ternary Ag—Cu—Ge alloy comprising, apart from incidental ingredients and impurities, not less than 92.5 wt % Ag, about 6.3 wt % Cu, about 1.2 wt % Ge, and about 4-8 ppm elemental B.

7. The method of claim 4, wherein the wire is of a ternary Ag—Cu—Ge alloy containing more than 93.5 wt % to 95.5 wt % Ag, from 0.5 to 3 wt % Ge, 1-40 ppm elemental boron and the remainder, apart from incidental ingredients and/or impurities, copper.

8. The method of claim 4, wherein the wire is of a ternary Ag—Cu—Ge alloy containing about 94.5 wt % Ag, 1.2 wt % Ge, 4-8 ppm elemental boron and the remainder, apart from incidental ingredients and/or impurities, copper.

9. The method of any of claims 1-3, wherein the silver wire has a solder or brazing alloy core.

10. The method of claim 9, wherein the non-core regions of the wire comprise 0.5-3 wt % Ge, the balance apart from incidental ingredients and/or impurities being silver.

11. The method of claim 10, wherein the non-core regions of the wire comprise about 1 wt % Ge.

12. The method of claim 9, 10 or 11, wherein the core is of a silver brazing alloy.

13. The method of claim 12, wherein said brazing alloy is of the Ag—Cu—Zn family containing at least 55 wt % Ag and from 0.5 to 3 wt % Ge.

14. The method of claim 11 or 12, wherein said alloy further comprises 0.1-0.3 wt % boron.

15. The method of any of claims 9-13, wherein said brazing alloy core has a solidus temperature of about 600° C. to about 705° C. and a liquidus temperature of about 650° C. to about 725° C.

16. The method of claim 15, wherein said brazing alloy has a solidus temperature of about 600° C. to about 630° C. and a liquidus temperature of about 650° C. to about 680° C.

17. The method of any preceding claim, wherein the links are closed at a rate of 100-250 links per minute.

18. The method of any preceding claim, wherein the links are closed using a laser of power 20-80 W.

19. The method of any preceding claim, wherein the links are closed using a laser of power about 30 W.

20. The method of any preceding claim, wherein the wire, prior to welding into said chain, has been annealed in an oxidizing atmosphere.

21. The method of claim 20, wherein the oxidising atmosphere is air.

22. The method of claim 20, wherein the oxidising atmosphere is a selectively oxidising atmosphere.

23. The method of claim 22, wherein the selectively oxidising atmosphere is a wet selectively oxidising atmosphere.

24. The method of claim 23, wherein the wet selectively oxidising atmosphere comprises any of:
(a) hydrogen gas and moisture;
(b) carbon monoxide and carbon dioxide;
(c) nitrogen, hydrogen, carbon monoxide, carbon dioxide, methane, and moisture;
(d) argon or nitrogen, and oxygen.

25. The method of claim 23 or 24, wherein the atmosphere has a dew point of at least +1° C.

26. The method of claim 25, wherein the atmosphere has a dew point in the range from +1° C. to +80° C.

27. The method of claim 25, wherein the atmosphere has a dew point in the range from +2° C. to +50° C.

28. A silver chain which comprises lengths of silver wire formed into successive links whose ends abut and are closed by brazed or welded joints, wherein the wire comprises at least 92.5 wt % Ag and about 0.5- about 3 wt % Ge.
